(19) United States
(12) Patent Application Publication
(10) Pub. No.: US 2010/0176958 A1
(43) Pub. Date: Jul. 15, 2010

(54) Electrically Adjustable Piece of Furniture and Method of Diagnosing an Operating State for an Electrically Adjustable Piece of Furniture

(76) Inventor: Walter Koch, Schwanberg (AT)

Correspondence Address: SLATER & MATSIL, L.L.P., 17950 PRESTON RD, SUITE 1000, DALLAS, TX, 75252-5793, US

(21) Appl. No.: 12/594,440

(22) PCT Filed: Apr. 4, 2008
(86) PCT No.: PCT/EP2008/054095

§ 371 Date: Mar. 19, 2010

(30) Foreign Application Priority Data
Apr. 5, 2007 (DE) 10 2007 016 640.2

(51) Int. Cl. G08B 21/00

(52) U.S. Cl. 340/635

(57) ABSTRACT

An electrically adjustable piece of furniture includes an adjusting device that includes at least one electrical drive, at least one control unit for activating the drive and at least one input device. A detection device detects at least one operating state of the adjusting device. A display device is arranged on the control unit and serves to indicate the operating state.

This patent application is a national phase filing under section 371 of PCT/EP2008/054095, filed Apr. 4, 2008, which claims the priority of German patent application 10 2007 016 640.2, filed Apr. 5, 2007, each of which is incorporated herein by reference in its entirety.

### TECHNICAL FIELD

The invention relates to an electrically adjustable piece of furniture, in particular, an adjustable bed or an adjustable table and a method of diagnosing an operating state for an electrically adjustable piece of furniture.

### BACKGROUND

Electrically adjustable furniture, for instance adjustable beds in hospitals or treatment chairs in medical practices, have been known for a long time. Adjustable furniture, e.g., beds or work tables, become more and more popular in private homes or industry as well.

A work table comprising a vertically adjustable work top is known from DE 299 18 086 U1. The work table comprises a drive, a control unit as well as an input device including a display. In this arrangement, the control unit is activated by the input device whose display reflects the respective adjustment of the work top.

The control unit used here can usually be adapted to a multitude of applications so that it must be set up for an individual application. Here and in later use it is useful to find out whether the adjusting device is in a proper operating state or whether there is a malfunction. In the case of a malfunction, the identification of the functional element causing the malfunction is particularly important in order to be able to take countermeasures. Malfunctions culminating in the complete failure regarding the adjustability of the piece of furniture can occur, which make it necessary to repair the piece of furniture to be able to guarantee a reliable function again.

The maintenance of an adjustable piece of furniture by a technician or even a repair is relatively time-consuming and expensive, in particular, if a malfunction cannot be immediately identified or if the functional element to be checked in respect of a malfunction is difficult to access. It has to be considered in the particular case whether the replacement of the drive, of the entire control unit and/or the input device or the operating section would be cheaper than a repair in the end.

### SUMMARY

In one aspect, an electrically adjustable piece of furniture of the above mentioned type allows a cost-effective possibility of diagnosing an operating state, in particular, for maintenance or repair purposes. Another aspect provides an economical and flexible method of diagnosing an operating state for such a piece of furniture.

According to at least one embodiment of the electrically adjustable piece of furniture, the latter comprises at least one electrical drive, at least one control unit for activating the drive, at least one input device for the control unit, a detection device for detecting at least one operating state of the adjusting device, and a display device arranged on the control unit and serves to indicate the operating state.

The detection device is configured to detect one or several operating states and, in the case of a particular operating state, in particular, when a malfunction occurs, to generate at least one signal which activates the display device. The detection device is preferably configured to generate different signals in case of different malfunctions or operating states. The different signals induce the display device to show different indications which designate the respective operating state or the respective malfunction.

According to at least one embodiment of the electrically adjustable piece of furniture, the control unit is designed so as to convert input signals into output signals which control the at least one electrical drive. Inter alia operating signals which are generated by means of an operating section formed as an input device serve as input signals. Other input signals are prepared operation data signals, e.g. sensor signals which are generated by sensors of the electrically adjustable piece of furniture. The output signals control the functions of the assigned electrical drive. These include start and stop signals for the drive as well as further signals which are decisive for the operational data of the electrical drive.

According to at least one embodiment of the electrically adjustable piece of furniture, the detection device is part of the control unit. This allows the detection device to integrate into the control system and to achieve a particularly reliable and economical signal detection or signal evaluation and signal processing in an advantageous way.

According to at least one advantageous embodiment of the electrically adjustable piece of furniture, the display device for indicating one or more operating states comprises at least one light-emitting diode (LED). According to an advantageous further development, one LED each is assigned to each functional unit of the electrically adjustable piece of furniture; the LED is activated to visually present an operating state assigned in each case, and is on or off.

According to further embodiments, the display device arranged on the control unit comprises a flat panel display, in particular, an LCD display or an organic LED display. In these embodiments, the detected operating states can be displayed not only in a binary way but also in interstages by numerical values or, e.g., by a bar diagram. Furthermore, a display is possible in the form of a graphic illustration which symbolizes the functional unit(s) in question and designates the associated operating states. An operating state is indicated by display symbols each assigned to the functional units so that the faulty functional unit is clearly identifiable.

A functional unit is understood to be at least each single electrical drive, the control unit and the input device or the operating section. Furthermore, elements which can be connected to the control unit, the drive or the input device, represent functional units. These also include, for instance, a port/plug connection or a functional element such as an anti-squeeze safety means which can optionally be connected to the control unit. It is also possible to assign one or several operating states to the power supply unit or the supply voltage per se as functional units. A failure of the line voltage supply itself can here be indicated by a battery-buffered control of the display device or is flagged by the non-functioning of all LEDs or of the flat screen display.

In an advantageous and particularly inexpensive further development, and should the operating state(s) be indicated by means of LEDs, the number of LEDs is reduced by one or more than one compared to the functional units whose operating states are to be indicated. In this case, an operating state or several operating states are signalized by all LEDs or sets of LEDs. Such operating states are indicated by the activation and simultaneous lighting of all LEDs or LED sets, for example.

In a preferred arrangement, it is provided that the LEDs are arranged in the control unit. It proves to be particularly advantageous for one LED each to be arranged locally adjacent to each port for the connection of a drive and the input device or the operating section. A further LED is arranged adjacent to the port for the power supply, if necessary. A separate LED is provided for the control unit itself. In the case of an operating state, a service engineer thus recognizes in a purely visual way by means of the activated LED which functional unit is in the operating state. This saves considerable other diagnostic effort. This embodiment thus offers a possible diagnosis as enabled by a presentation of the functional element on a flat-panel display; in addition, it is more robust.

This embodiment of the electrically adjustable piece of furniture can also be used in cases where only two functions, e.g., “up-down” or “tilt-stop tilting”, are provided for the input device or the operating section. The operating section can therefore remain unmodified and economical without the need of renouncing a diagnosis of an operating state. A simple and clear presentation or diagnosis of an operating state is possible with the aid of the optical and local indication of the operating state. Needless to say that the operating section can also comprise a monitor screen in a manner known per se, indicating to the user the position of the operated element, e.g., the work plate.

In a further development of an embodiment, the display device includes an electrical supply including a battery. This has the special advantage that the operating state(s) is also indicated in case of power failure, since the battery takes over the power supply of the display device.

The advantage of all embodiments is that a service engineer can immediately identify the impaired functional unit and exchange it in case of need. On the other hand, the user of the piece of furniture is not provided with information about operating states which he does not need for operation because the display device is arranged on the control unit. In this context, the term “arranged on the control unit” means a spatial assignment between the display device and the control unit. It is thus provided that the display device comprises several individual elements such as individual LEDs outside the housing of the control unit or a separately housed display device next to the housing of the control unit or an integration of this and further embodiments of the display device in the control unit itself or in the housing of the control unit.

In at least one embodiment of the method of diagnosing an operating state for an electrically adjustable piece of furniture, operating state data of an adjusting device for the piece of furniture is detected and compared with target data. A change in the operating state is indicated with the aid of the display device if there is a predefined deviation criterion of the operating state data with respect to the target data.

To this end, at least one operating state signal is generated with which a display device is activated to indicate the operating state.

It proves to be of particular advantage if a separately generated operating state signal is assigned to each functional unit of the electrically adjustable piece of furniture for the operating states to be displayed; this signal then activates a display device provided for this case of operating state or does not activate it if the operating state signal is not generated. It is particularly preferred that each operating state signal activates an assigned LED or a display element of a flat-panel display as a display unit of the display device.

Further advantageous details and arrangements are apparent from the claims and the drawings.

### BRIEF DESCRIPTION OF THE DRAWINGS

The electrically adjustable piece of furniture is explained in more detail below on the basis of embodiments and the drawings.

FIG. 1 shows a schematic diagram of an electrical adjusting device of an electrically adjustable piece of furniture,

FIG. 2 shows a schematic diagram of an electrical control unit,

FIG. 3 shows a schematic diagram of an electrical operating section including a display device,

FIG. 4 shows a schematic circuit arrangement for activating an LED in the case of an operating state and

FIG. 5 shows a flowchart of a method of diagnosing an operating state for an electrically adjustable piece of furniture.

### DETAILED DESCRIPTION OF ILLUSTRATIVE EMBODIMENTS

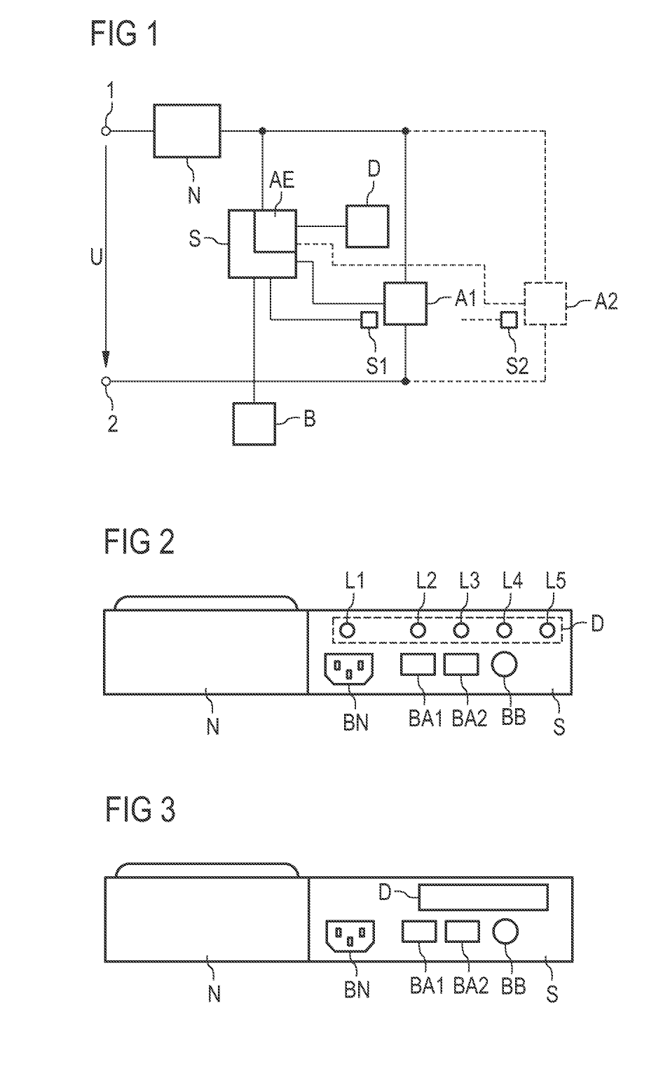

FIG. 1 shows a schematic diagram of an electrical adjusting device of an electrically adjustable piece of furniture, e.g. a vertically adjustable work table or a bed including an adjustable head section and/or foot section.

The adjusting device comprises a power supply including a voltage U, which is applied to the power supply terminals 1 and 2. The supply voltage is transformed to low voltage and rectified at least in part in the power supply unit N. The rectified voltage is supplied to a control unit S for activating the electrical drive(s). The adjusting device further comprises at least one electrical drive A1 such as a direct current or alternating current motor. If needed, further electrical drives A2 are provided which are all connected in parallel on their supply side. Sensors S1 and S2, which are only exemplified, are elements of a detection device AE and measure operating state data or operating parameters of the electrical drives A1 and A2, respectively. Each of the sensors detects the speed or also the sense of rotation and the torsional moment, for example. The temperature is also considered, where required.

The control unit S is connected to the detection device AE to detect at least one operating state of the adjusting device. In particular, the detection device AE is integrated into the control and arranged in the same housing. The control unit S is preferably attached to the table or bed such that it is not readily visible.

The adjusting device for the piece of furniture further comprises an input device B designed in the embodiment as an operating section which has a cable connection to the control unit and is operated by a user in a state remote from the control units. It is also possible, however, to integrate the operating section into the control unit and to perform the operator inputs to the control unit through a mechanical activation of keys of the control unit. The operating section can be accessed through an opening of a tabletop, for instance, while the control unit is mounted below the tabletop. In another embodiment, the input device transmits input data to the control unit in a wireless way.

The detection device AE activates a display device D for indicating an operating state. In the embodiment, the display device D is arranged so as to be separate from the detection device AE. For instance, the display device D is provided in the form of an LED display or LCD display which is designed as a separate component and on which the control unit S is arranged.

According to FIG. 2, the display device D is integrated into the control unit S. The display device D itself includes light-emitting diodes (LED) L1 to L5. The LEDs L1 to L4 are respectively assigned to a port of the control unit S. In particular, LED L1 pertains to the power supply port BN, LED L2 to the port BA1 for the drive A1, LED L3 to the port BA2 for the drive A2, and LED L4 to the port BB for the operating section. LED L5 is provided to identify an operating state in the control unit S itself. The power supply N and the detection device AE (not shown) are co-integrated into the control unit S. It is, of course, provided that further LEDs perform the indication of further operating states of the functional units.

According to FIG. 3, an LCD display device D is integrated into the control unit. The display D indicates the functional unit and the associated operating state, for example on the part of drive A1, as illustrated.

The detection device AE detects the decisive information of the functional units, e.g., by means of sensors, and evaluates it. As soon as an operating state occurs, the detection device AE recognizes this and activates a circuitry in the presence of a deviation criterion, the circuitry activating an LED or a display segment of the LCD display.

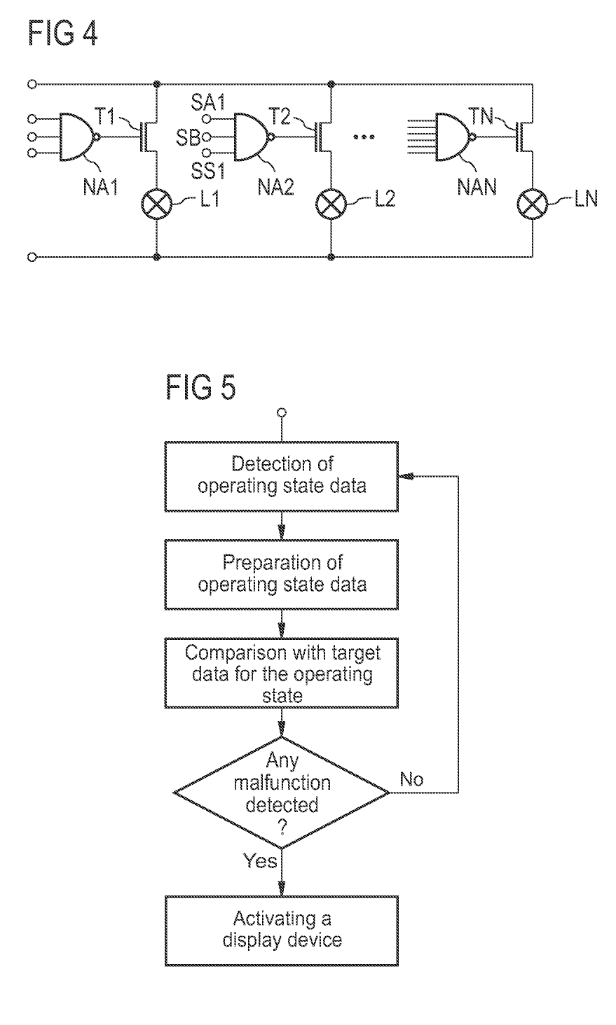

According to FIG. 4, the signal evaluation is carried out with NAND gates NA1, NA2, . . . NAN. For example, if there is a malfunction of the drive A1, no sensor signal SS1 is generated although the control unit S functions properly and the control signals SB of the operating section and SA1 for the drive A1 are applied. The detection device AE then detects the interruption of the normal operating state because a deviation criterion is fulfilled with the sensor signal missing. In the detection device AE, the gate NA2 generates an output signal which turns on the transistor T2, so that the LED L2 is on and indicates the interruption or the changed operating state.

Of course, the signal evaluation of the detection device AE is not restricted to NAND gates. Other circuits which activate an LED for indicating operating states are also left to the discretion of a person skilled in the art.

The indication of operating states is likewise possible with a control program provided in the detection device. To this end, the operating state data is evaluated according to the control program and an operating state signal for the display device is generated if there is a criterion for a changed indication of the operating state. Apart from the above mentioned operating data, the piece of furniture can comprise additional sensors (not shown) for detecting stop positions or squeezing forces, for example. Furthermore, the operating state data can comprise motor speeds, motor currents, motor voltages or motor torques of the electrical drive, lengths of run or predetermined positions. For example, if any determined sensor values do not coincide with expected values or if the configuration stored in a data memory is undetermined in itself, this is recognized and displayed by the control program of the detection device AE.

It goes without saying that the operating state display is not tied to a permanent indication of an LED or an LCD display. An operating state is also clearly identified by flashing.

FIG. 5 shows a flowchart of a method of analyzing an operating state of an electrically adjustable piece of furniture.

In a first step, operating state data of an electrically adjustable piece of furniture is detected, e.g. control signals of the control unit or configuration data stored in a data memory or data from sensors.

A detection of operating state data is carried out continuously or at regular intervals or is triggered by an interruption of an operating state or a user action.

In a next step, the detected operating state data is prepared by means of the detection device for a subsequent comparison with target data.

In another step, the evaluated or prepared operating state data of the detection device is compared with target data for the operating state. Thereafter, it is checked whether the criteria for the presence of a change in the indication of the operating state are fulfilled.

If there is a predefined change in an operating state, a display device is activated in the following step, which indicates the changed operating state of the assigned functional element.

1. An electrically adjustable piece of furniture, comprising:
an adjusting device that comprises at least one electrical drive, at least one control unit for activating the drive, and at least one input device,
a detection device for detecting at least one operating state of the adjusting device; and
a display device arranged on the at least one control unit and serving to indicate the at least one operating state; the display device including light-emitting diodes, each light-emitting diode indicating a different operating state.

2. The electrically adjustable piece of furniture according to claim 1, wherein the detection device is configured to indicate different operating states in different ways by means of the display device.

3. The electrically adjustable piece of furniture according to claim 1, wherein the detection device is part of the at least one control unit.

4. The electrically adjustable piece of furniture according to claim 1, wherein the display device is integrated into the at least one control unit.

5. (canceled)

6. The electrically adjustable piece of furniture according to claim 1, wherein one light-emitting diode is assigned to each functional unit of the adjusting device.

7. The electrically adjustable piece of furniture according to claim 1, wherein one light-emitting diode each is assigned to several functional units of the adjusting device and a group of several of the light-emitting diodes is assigned to a further functional unit.

8. The electrically adjustable piece of furniture according to claim 1, wherein at least one of the light-emitting diodes in the at least one control unit is assigned locally to an element of a functional unit.

9. The electrically adjustable piece of furniture according to claim 1, wherein the display device further comprises an LCD display respectively indicating a different operating state by a different display illustration.

10. The electrically adjustable piece of furniture according to claim 1, wherein the detection device comprises a memory for storing at least target data and a comparison device for comparing the target data with operating state data.

11. A method of diagnosing an operating state for an electrically adjustable piece of furniture, the method comprising:
indicating at least one operating state by means of a display device,
detecting operating state data of an adjusting device for the adjustable piece of furniture,
comparing the operating state data with target data,
indicating a change in the at least one operating state when there is a predefined deviation criterion of the operating state data with respect to the target data, and
wherein, for a plurality of functional units of the adjusting device, an individual operating state signal is generated which controls a light-emitting diode associated with the at least one operating state.

12. The method of diagnosing an operating state according to claim 11, wherein one light-emitting diode is associated with each of the plurality of functional units of the adjusting device.

13. (canceled)

14. The method of diagnosing an operating state according to claim 11, wherein the adjusting device comprises at least one electrical drive, at least one control unit for activating the drive, and at least one input device.

15. The method of diagnosing an operating state according to claim 14, wherein the electrically adjustable piece of furniture comprises:
the adjusting device;
the display device; and
a detection device for detecting the operating state data of the adjusting device.

16. The method of diagnosing an operating state according to claim 15, wherein the display device is arranged on the at least one control unit.

17. The method of diagnosing an operating state according to claim 16, wherein the display device includes light-emitting diodes.

18. The method of diagnosing an operating state according to claim 16, wherein the display device is integrated into the at least one control unit.

19. The method of diagnosing an operating state according to claim 11, wherein one light-emitting diode each is assigned to several functional units of the adjusting device and a group of several light-emitting diodes is assigned to a further functional unit.

20. The method of diagnosing an operating state according to claim 11, wherein at least one light-emitting diode in the at least one control unit is assigned locally to an element of a functional unit.
